(19) United States
(12) Patent Application Publication
(10) Pub. No.: US 2018/0129846 A1
(43) Pub. Date: May 10, 2018

(54) TWO DIMENSION CODE OPERATING METHOD AND TERMINAL

(71) Applicant: GIONEE COMMUNICATION EQUIPMENT CO.,LTD. SHENZHEN, Shenzhen, GD (CN)

(72) Inventors: Pan HUANG, Shenzhen (CN); Zegang YE, Shenzhen (CN)

(73) Assignee: GIONEE COMMUNICATION EQUIPMENT CO.,LTD. SHENZHEN, Shenzhen (CN)

(21) Appl. No.: 15/539,041

(22) PCT Filed: May 28, 2015
(86) PCT No.: PCT/CN2015/080005

§ 371 Date: Oct. 23, 2017

(30) Foreign Application Priority Data
Dec. 19, 2014 (CN) 201410802148.7
Dec. 19, 2014 (CN) 201410805383.X

(51) Int. Cl. G06K 7/14

(52) U.S. Cl. CPC G06K 7/1417; G06K 7/1452

(57) ABSTRACT

Disclosed in an embodiment of the present invention are a two dimension code operating method and terminal, the two dimension code operating method including: scanning a target two dimension code storing option information of at least two options; determining orientation information of the terminal if the terminal scans the target two dimension code; determining a target option corresponding to the orientation information according to the mapping relationship between the scanning orientation and the at least two options; outputting a content corresponding to the option information of the target option. An embodiment of the present invention is employed to improve operability of the two dimension code during operating.

### CROSS REFERENCE TO RELATED APPLICATIONS

This present application claims the benefit of priority to China Patent Application No. 201410805383.X, filed in Chinese Patent Office on Dec. 19, 2014, and entitled “TWO DIMENSION CODE OPERATING METHOD”, and claims the benefit of priority to China Patent Application No. 20140802148.7, filed in Chinese Patent Office on Dec. 19, 2014, and entitled “TERMINAL”, the contents of which are hereby incorporated by reference in their entireties.

### FIELD

The present disclosure relates to the field of electronic technology, and more particularly, to a two dimension code operating method and a terminal.

### BACKGROUND

A two dimension code (also called two dimension barcode) is a black and white image which consists of particular geometric figures distributed in a plane (two-dimensional direction) according to certain rules and is used to record data and symbol information. That is, the two dimension barcode consists of black geometric figures arranged, according to certain rules, in a two-dimensional plane on a white background to finally form a graphical image that stores information which can be read by an imaging device such as a camera. With the development of Internet technology, the two dimension code becomes a media to express and transfer the information efficiently. When scanning the two dimension code by use of a terminal, a user can quickly acquire the information stored in the two dimension code and process the information in order to open a website, unlock a screen, add a friend or make a payment, etc.

As the growing popularization of two dimension code technology, a two dimension code can store more and more information. However, during the operation process of the current two dimension code, a user can not quickly access a target content that the user wants to see according to the user's requirements, that is, a user cannot quickly obtain a desired target content with himself own needs, thus operability of the two dimension code during operating is low.

### SUMMARY

An embodiment of the present disclosure provides a two dimension code operating method and a terminal, which can improve operability of the two dimension code during operating.

The embodiment of the present disclosure provides a video studio creating method. The video studio creating method may include the steps of:

scanning a target two dimension code; wherein, the target two dimension code stores option information of at least two options;

determining orientation information of a terminal when the terminal scans the target two dimension code;

determining a target option corresponding to the orientation information according to a mapping relationship between scanning orientations and the at least two options; and

outputting a content corresponding to the option information of the target option.

Correspondingly, the embodiment of the present disclosure further provides a terminal. The terminal may include:

a scanning unit, used to scan a target two dimension code; wherein, the target two dimension code stores option information of at least two options;

a first determining unit, used to determine orientation information of the terminal when the terminal scans the target two dimension code;

a second determining unit, used to determine a target option corresponding to the orientation information according to a mapping relationship between scanning orientations and the at least two options; and

an outputting unit, used to output a content corresponding to the option information of the target option.

By implementing the embodiment of the present disclosure, when scanning a target two dimension code, a terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing the embodiment, operability of the two dimension code during operating can be improved.

### BRIEF DESCRIPTION OF THE DRAWINGS

In order to illustrate the embodiments or existing technical solutions more clearly, a brief description of drawings that assists the description of embodiments of present disclosure or existing art will be provided below.

FIG. 1 is a flowchart of a two dimension code operating method according to a first embodiment of the present disclosure;

FIG. 1a is a flowchart of a method for determining a slant angle according to FIG. 1;

FIG. 1b is a diagram of a scanning orientation according to FIG. 1a;

FIG. 1c is a diagram of another scanning orientation according to FIG. 1a;

FIG. 1d is a block diagram of a two dimension code according to the first embodiment of the present disclosure;

FIG. 2 is a flowchart of a two dimension code operating method according to a second embodiment of the present disclosure;

FIG. 2a is a diagram of a first scanning orientation according to FIG. 2;

FIG. 2b is a diagram of a second scanning orientation according to FIG. 2;

FIG. 2c is a diagram of a third scanning orientation according to FIG. 2;

FIG. 2d is a diagram of a scanning interface according to FIG. 2;

FIG. 3 is a flowchart of a two dimension code operating method according to a third embodiment of the present disclosure;

FIG. 3a is a flowchart of a first method for establishing a mapping relationship according to the third embodiment as shown in FIG. 3 of the present disclosure;

FIG. 3b is a flowchart of a second method for establishing a mapping relationship according to the third embodiment as shown in FIG. 3 of the present disclosure;

FIG. 3c is a diagram of a scanning orientation according to FIG. 3;

FIG. 4 is a block diagram of a terminal according to a first embodiment of the present disclosure;

FIG. 5 is a block diagram of a terminal according to a second embodiment of the present disclosure;

FIG. 5a is a block diagram of a first displaying unit as shown in FIG. 5;

FIG. 6 is a block diagram of a terminal according to a third embodiment of the present disclosure;

FIG. 6a is a block diagram of a first determining unit as shown in FIG. 6; and

FIG. 7 is a block diagram of a terminal according to a fourth embodiment of the present disclosure.

### DETAILED DESCRIPTION OF ILLUSTRATED EMBODIMENTS

The disclosure will now be described in detail on the basis of preferred embodiments and drawings. It is to be understood that various changes may be made without departing from the spirit and scope of the present disclosure and the embodiments of the present disclosure and features in the embodiments can be combined with each other.

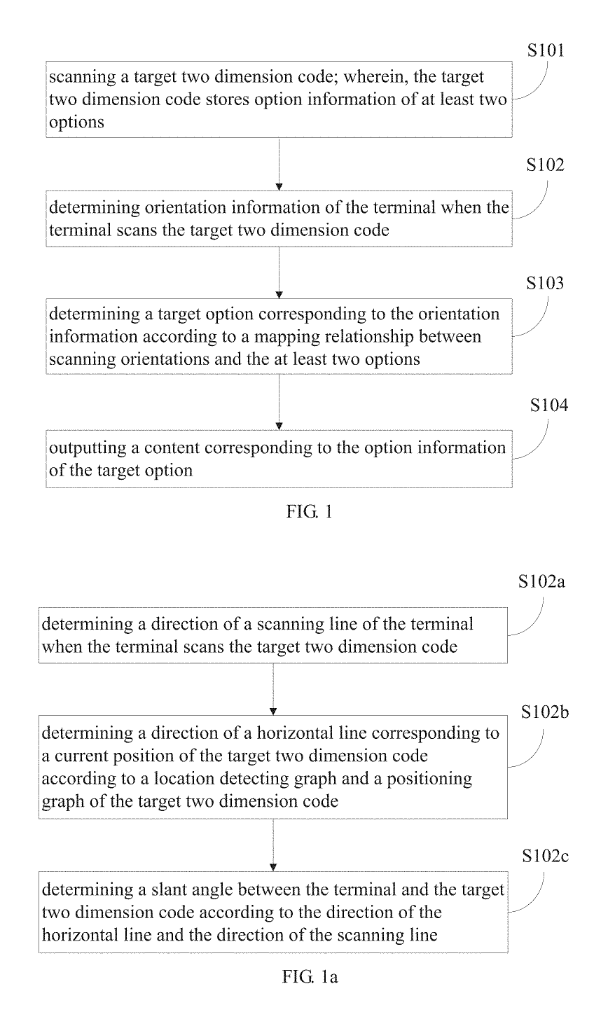

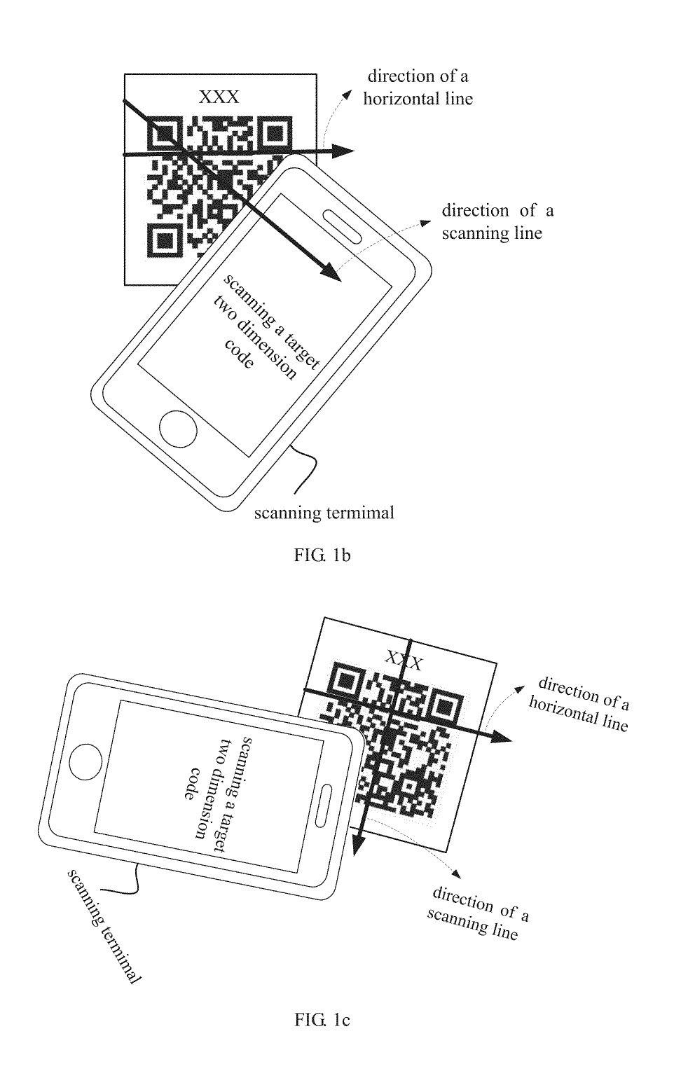

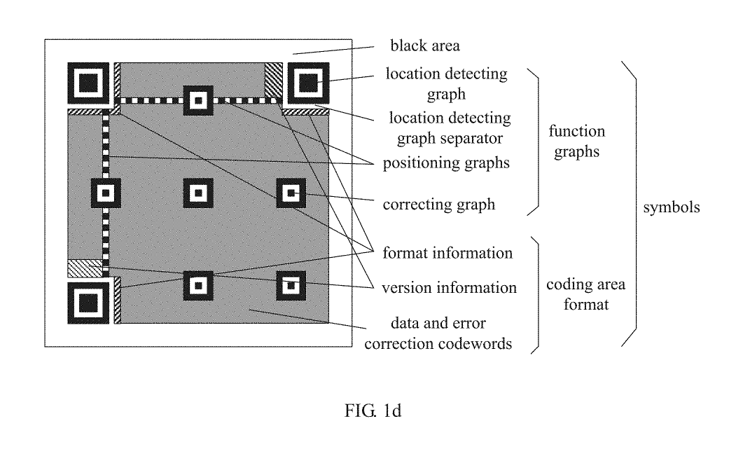

An embodiment of the present disclosure provides a two dimension code operating method. In the two dimension code operating method, when scanning a target two dimension code, a terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing the embodiment, when a user scans a two dimension code by use of a terminal, the terminal can output corresponding target contents according to scanning orientations of the terminal. Thus, operability of the two dimension code during operating can be improved. The two dimension code operating method and a terminal according to the embodiments of the present disclosure will now be respectively introduced in detail below combined with the drawings FIGS. 1-7.

In the embodiments of the present disclosure, the mentioned terminal may be a mobile phone, a tablet computer, a two dimension code scanning terminal or a two dimension code scanning device, etc., which is not limited in detail in the embodiments. Actually, any device which is able to scan the two dimension code can be considered as the terminal in the embodiments. The two dimension code operating method according to the embodiments of the present disclosure can be integrated in a two dimension code scanning program. In order to facilitate understanding, a mobile phone where the two dimension code scanning program is loaded is taken here as an example of the terminal in the following embodiments. It should be noted that, besides the mobile phone, any device, equipment or terminal where the present disclosure can apply belongs to the scope of the present disclosure.

Referring to FIG. 1, FIG. 1 is a flowchart of a two dimension code operating method according to a first embodiment of the present disclosure. In this embodiment, the two dimension code operating method according to the first embodiment of the present disclosure may include the following steps.

Step S101, scanning a target two dimension code; wherein, the target two dimension code stores option information of at least two options.

With the development of two dimension code technology, the capacity of a two dimension code for storing data gets larger and larger. However, this advantage of the two dimension code for storing larger data is not fully realized. According to current two dimension code scanning methods, no matter what kind of orientation a terminal uses to scan a two dimension code, the way for displaying information is single after the terminal scans the two dimension code. For example, when the two dimension code stores lots of information, a user cannot quickly find a data content that the user wants to access from the lots of information.

In this embodiment, the option information of the at least two options can be stored previously in a two dimension code. When a terminal scans the two dimension code, different options are accessed according to scanning orientations, which enriches the ways for scanning the two dimension code. For example, the option information may include web sites and text information, etc. Wherein, the text information may be contact information, product information or parameter information of products, etc. In detail, the option information is set according to an actual usage scenario, which is not limited in this embodiment. In specific implementations, a terminal scans the target two dimension code; wherein, the target two dimension code stores the option information of the at least two options.

In order to facilitate understanding, taking a shopping website as a first example, the option information may be a web site corresponding to any information in the shopping website and/or an identifier of the any information, such as the web site corresponding to the home page of the shopping website and the identifier “home page”, the web site corresponding to information of electronic products in the shopping website and the identifier “electronics”, or the web site corresponding to information of cosmetics and the identifier “cosmetics”, etc. In addition, a usage scenario of a business card is taken here as a second example. Usually, the business card includes information such as a name, a telephone number, an email address and a title, etc., and the information can be considered as the option information described in this embodiment. Moreover, taking an address book as a third example, part of or all contact information can be integrated in a two dimension code, thus the option information may include a name, a telephone number and other information of each contact person. Furthermore, taking electronic business as a fourth example, parameter information of some electronic products can be integrated in a two dimension code. In order to facilitate illustrating, taking a television as an example of the electronic products, the parameter information of the television may include color, size, resolution ratio, screen ratio, a brand and other information, and can be considered as the option information described in this embodiment. Besides, taking a usage scenario of product promotion as a fifth example, information of multiple products for sale can be integrated in a two dimension code, thus the option information may include the information of each product, such as a product name, original price, promotional price and a promotional date, etc. Taking a usage scenario for claiming a prize as a sixth example, assuming that there are three awards, the option information may include award identifiers and specific rewards corresponding to the award identifiers. For example, the award identifiers are “the first prize”, “the second prize” and “the third prize”, and the specific rewards are corresponding prize names. In specific implementations, the option information can be set according to users' requirements, which is no longer enumerated one by one in this embodiment.

Step S102, determining orientation information of a terminal when the terminal scans the target two dimension code.

In specific implementations, the orientation information may be a scanning orientation of the terminal itself. Usually, the orientation information can be obtained via sensor data which is acquired by use of an orientation sensor. Wherein, the orientation sensor may be a gravity sensor, a gyroscope, a geomagnetic sensor, an acceleration sensor, an angular velocity sensor or an inclinometer, etc., which is not limited in detail in this embodiment. Of course, the orientation information may also be a slant angle between the terminal and the target two dimension code, which is not limited in detail in this embodiment.

As one of examples, the orientation information includes the slant angle between the terminal and the target two dimension code. In specific implementations, a method for acquiring the slant angle can be shown in FIG. 1a, and FIG. 1a is a flowchart of a method for determining a slant angle according to FIG. 1. The method for determining a slant angle according to FIG. 1 may include the steps S102a to S102c.

Step S102a, determining a direction of a scanning line of the terminal when the terminal scans the target two dimension code.

Usually, from users' perspective, the direction of the scanning line is a horizontal direction which is parallel to the upper edge of the terminal and is from left to right. In order to facilitate understanding, referring to FIG. 1b, FIG. 1b is a diagram of a scanning orientation according to FIG. 1a. It should be known that, according to the scanning orientation, the direction of the scanning line of the terminal when the terminal scans the target two dimension code is “the direction of the scanning line” as shown in FIG. 1b. For another example, referring to FIG. 1c, FIG. 1c is a diagram of another scanning orientation according to FIG. 1a. It should be known that, according to the scanning orientation, the direction of the scanning line of the terminal when the terminal scans the target two dimension code is “the direction of the scanning line” as shown in FIG. 1c.

Step S102b, determining a direction of a horizontal line corresponding to a current position of the target two dimension code according to a location detecting graph and a positioning graph of the target two dimension code.

A quick response (QR) code, namely a black and white image which consists of particular geometric figures distributed in the plane (two-dimensional direction) according to certain rules, is used to record data and symbol information. The concept of bit streams “0” and “1” which constitute internal logic foundation of a computer is subtly utilized for QR code coding, and several geometric figures corresponding to the binary system are used to express text and numerical information, which are automatically read and analyzed by an image input device or an optoelectronic scanning device in order to realize automatic information processing. In order to facilitate understanding, referring to FIG. 1d, FIG. 1d is a block diagram of a two dimension code according to the first embodiment of the present disclosure. Wherein, a location detecting graph, a location detecting graph separator and a positioning graph are used to position the QR code. For each QR code, when its position is fixed, the size specification and the geometric distribution of the QR code are different from other QR codes. For correcting graphs, when the specification of the QR code is determined, the number and the positions of the correcting graphs are also determined. Format information indicates the error correction level of the QR code. Wherein, there are 4 error correction levels in total, which are represented as L, M, Q and H respectively. Version information is the specification of the QR code, and QR code symbols totally have matrix (generally in black and white) with 40 kinds of specification. From 21×21 (version 1) to 177×177 (version 40), symbols of each version have 4 more modules on each side than those of the previous version. Data and error correction codewords are QR code information that is indeed saved, and the error correction codewords are used to correct errors brought by QR code damage.

In specific implementations, the direction of the horizontal line corresponding to the current position of the target two dimension code can be determined according to the location detecting graph and the positioning graph of the target two dimension code. From users' perspective, the direction of the horizontal line of the target two dimension code is usually a horizontal direction which is parallel to the upper edge of the target two dimension code and is from left to right. For example, referring to FIG. 1b, it should be known that, according to the scanning orientation as shown in FIG. 1b, the direction of the horizontal line of the target two dimension code is “the direction of the horizontal line” as shown in FIG. 1b. For another example, referring to FIG. 1c, it should be known that, according to the scanning orientation as shown in FIG. 1c, the direction of the horizontal line of the target two dimension code is “the direction of the horizontal line” as shown in FIG. 1c.

Step S102c, determining a slant angle between the terminal and the target two dimension code according to the direction of the horizontal line and the direction of the scanning line.

After the direction of the scanning line of the terminal when the terminal scans the target two dimension code and the direction of the horizontal line corresponding to the current position of the target two dimension code are determined by the steps S102a and S102b respectively, the slant angle between the terminal and the target two dimension code can be determined according to determined direction of the scanning line and determined direction of the horizontal line. In order to facilitate understanding, for example, according to the scanning orientation as shown in FIG. 1b, the slant angle between the terminal and the target two dimension code can be determined to be 45 degrees. For another example, according to the scanning orientation as shown in FIG. 1c, the slant angle between the terminal and the target two dimension code can be determined to be 90 degrees.

It should be noted that, in specific implementations, the slant angle between the terminal and the target two dimension code can also be obtained by other ways, which is not limited in detail in this embodiment.

Step S103, determining a target option corresponding to the orientation information according to a mapping relationship between scanning orientations and the at least two options.

In specific implementations, after scanning the target two dimension code, the terminal can acquire the option information of the at least two options stored in the target two dimension code, in order to determine specific option number, and establish the mapping relationship between the scanning orientations and the at least two options according to a preset rule, in order to determine the target option corresponding to the orientation information.

In order to facilitate understanding, taking the slant angle described above as an example of the orientation information, assuming that the option number of the option information stored in the two dimension code is obtained to be 4 and the 4 options are identified as A, B, C and D respectively. A mapping relationship between the scanning orientations and the 4 options can be shown in Tab. 1, and Tab. 1 is a chart of a mapping relationship between scanning orientations and options according to FIG. 1.

TABLE 1

| slant angles | | options |
|---|---|---|
| 0 | degree | A |
| 90 | degrees | B |
| 180 | degrees | C |
| 270 | degrees | D |

According to Tab. 1, it can be known that, when the slant angle between the terminal and the target two dimension code is 0 degree, the target option corresponding to a current scanning orientation of the terminal is determined to be the option A; when the slant angle between the terminal and the target two dimension code is 90 degrees, the target option corresponding to a current scanning orientation of the terminal is determined to be the option B; when the slant angle between the terminal and the target two dimension code is 180 degrees, the target option corresponding to a current scanning orientation of the terminal is determined to be the option C; and when the slant angle between the terminal and the target two dimension code is 270 degrees, the target option corresponding to a current scanning orientation of the terminal is determined to be the option D. It should be noted that, the mapping relationship as shown in Tab. 1 is just an example. In specific implementations, the mapping relationship between the scanning orientations and the options can be set according to actual requirements, which is not limited in this embodiment.

Step S104, outputting a content corresponding to the option information of the target option.

After the target option corresponding to the current scanning orientation of the terminal is determined by the above steps, according to the option information of the target option, the content corresponding to the option information is output. Therefore, a user can access different option contents via different scanning orientations, which can enrich the ways for scanning a two dimension code and displaying information. At the same time, the user can quickly access a content that the user wants to access according to the user's requirements, and efficiency of scanning the two dimension code is high, thus operability of the two dimension code during operating can be improved. Taking a usage scenario where the two dimension code is used to store web site information as a first example, the option information may include option identifiers and web sites. Then, according to the web site corresponding to the target option in the option information, a webpage corresponding to the target option is output. In addition, taking a usage scenario where the two dimension code is used to store contact information as a second example, the option information may include option identifiers and contact information. Then, according to the contact information corresponding to the target option in the option information, the contact information corresponding to the target option is output. Moreover, taking a usage scenario where the two dimension code is used to store product information as a third example, the option information may include option identifiers and product information. Then, according to the product information corresponding to the target option in the option information, the product information corresponding to the target option is output. In specific implementations, the output content is related to an actual usage scenario, which is not limited in this embodiment.

In the two dimension code operating method described in this embodiment, when scanning a target two dimension code, a terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing, this embodiment, when a user scans a two dimension code by use of a terminal, the terminal can output corresponding target contents according to scanning orientations of the terminal, which can improve operability of the two dimension code during operating.

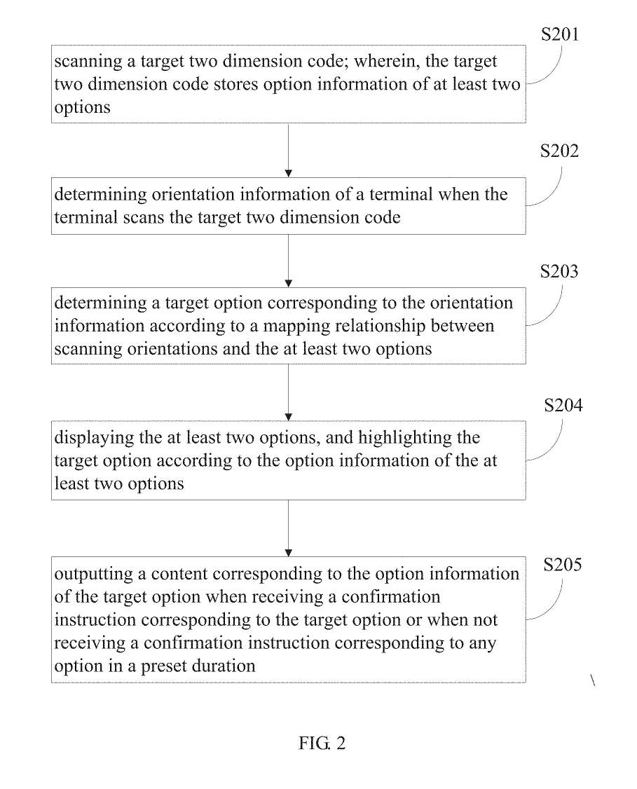

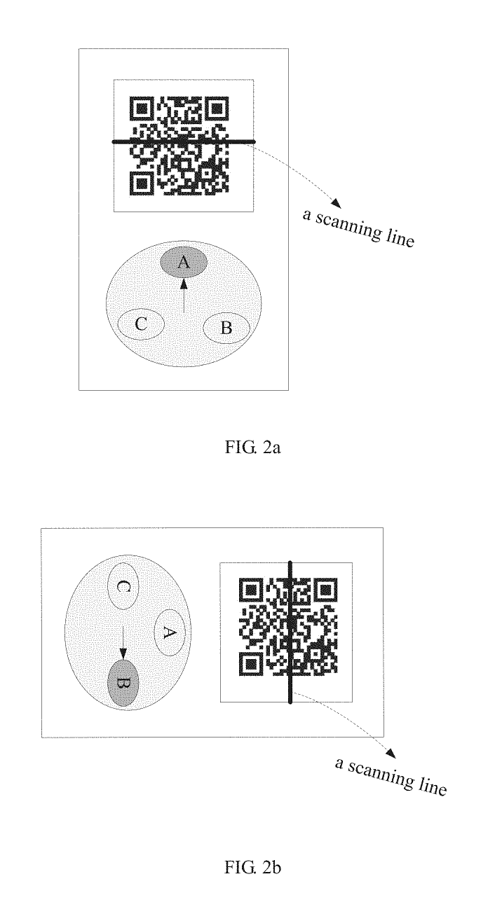

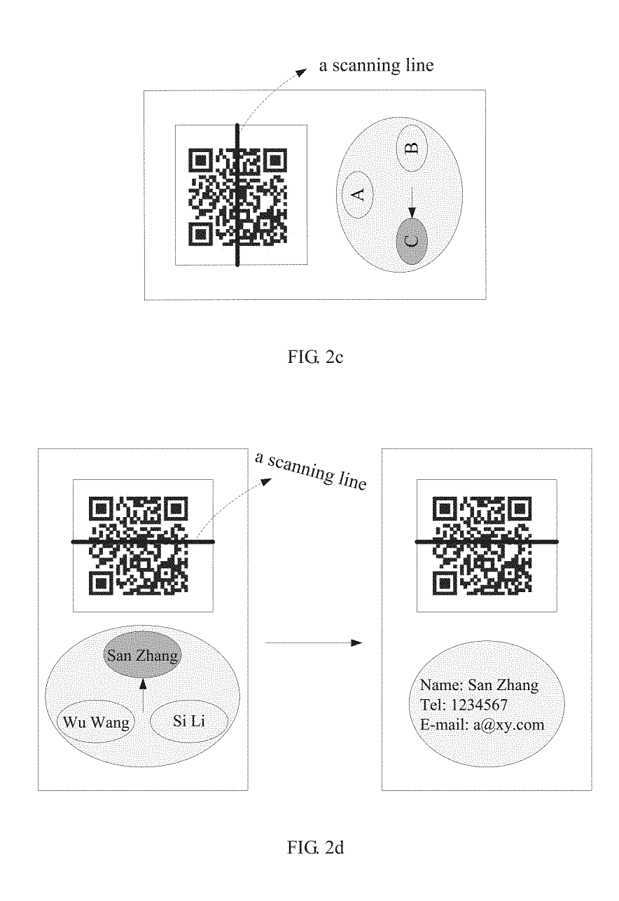

Referring to FIG. 2, FIG. 2 is a flowchart of a two dimension code operating method according to a second embodiment of the present disclosure. In this embodiment, the two dimension code operating method according to the second embodiment of the present disclosure may include the following steps.

Step S201, scanning a target two dimension code; wherein, the target two dimension code stores option information of at least two options.

In consideration of information diversity, in this embodiment, the target two dimension code stores the option information of the at least two options. Wherein, an option is a preset portal which enables a user to access data after the user scans a two dimension code. In specific implementations, a preset separator can be added between the option information of the options, in order to distinguish the option information of different options. In order to facilitate understanding, a shopping website is taken here as a first example. In specific implementations, one option of the at least two options may be the home page of the shopping website, and the option information of the option may be web site information of the home page. Other options may be product classes in the home page, such as maternal and child, electronics, kitchenware and cosmetics, etc., and the option information of a product class may be web site information corresponding to the product class. Wherein, specific options can be set according to actual requirements. For example, the specific options can be several product classes at the very top of page view (PV), but which is not limited in detail in this embodiment.

In order to facilitate understanding, taking a usage scenario where the two dimension code is used to store contact information as a first example, the option information may include a name of each contact person, a telephone number corresponding to the name and other information. In addition, taking a usage scenario where the two dimension code is used to store business card information as a second example, the option information may include a name, a telephone number, a title and other information. Taking a usage scenario where the two dimension code is used to store parameter information of a single product as a third example, the option information may include a brand, size and specification of the product and other information. Taking a usage scenario where the two dimension code is used to store product information of each product as a fourth example, the option information may include product name of each product, parameters corresponding to the each product and other information. In specific implementations, the option information can be set according to actual requirements, which is no longer enumerated here one by one.

Step S202, determining orientation information of a terminal when the terminal scans the target two dimension code.

In specific implementations, the orientation information may be a scanning orientation of the terminal itself. Usually, the orientation information can be obtained via sensor data which is acquired by use of an orientation sensor. Wherein, the orientation sensor may be a gravity sensor (G-sensor), a gyroscope, a geomagnetic sensor, an acceleration sensor, an angular velocity sensor or an inclinometer, etc., which is not limited in detail in this embodiment. For example, when a mobile phone scans the target two dimension code while the mobile phone is placed horizontally, G-sensor data (x, y, z) is equal to (0, 0, 10); when a mobile phone scans the target two dimension code while the mobile phone is placed vertically, G-sensor data (x, y, z) is equal to (0, 10, 0); when a mobile phone scans the target two dimension code while the mobile phone is laid to right, G-sensor data (x, y, z) is equal to (−10, 0, 0); and when a mobile phone scans the target two dimension code while the mobile phone is laid to left, G-sensor data (x, y, z) is equal to (10, 0, 0).

Of course, in specific implementations, the orientation information may also be a slant angle between the terminal and the target two dimension code, and related specific details can be seen by reference to the step S102 in the above embodiment.

Step S203, determining a target option corresponding to the orientation information according to a mapping relationship between scanning orientations and the at least two options.

In order to facilitate understanding, a usage scenario where the orientation information of the terminal is acquired by use of a gravity sensor is taken here as an example. After scanning the target two dimension code, the terminal acquires the option information stored in the target two dimension code. Assuming that the target two dimension code stores option information of 3 options and the 3 options are identified as A, B and C respectively. A mapping relationship between the scanning orientations and the 3 options is built according to a preset rule. In order to facilitate understanding, assuming that G-sensor data (0, 0, 10) or (0, 10, 0) corresponds to the option A, as shown in FIG. 2a, and FIG. 2a is a diagram of a first scanning orientation according to FIG. 2; G-sensor data (−10, 0, 0) corresponds to the option B, as shown in FIG. 2b, and FIG. 2b is a diagram of a second scanning orientation according to FIG. 2; and G-sensor data (10, 0, 0) corresponds to the option C, as shown in FIG. 2c, and FIG. 2c is a diagram of a third scanning orientation according to FIG. 2. Hence, if the orientation information of the terminal when the terminal scans the target two dimension code is (−10, 0, 0), the target option can be determined to be the option B, as shown in FIG. 2b. It should be noted that, the above description is just an example.

Step S204, displaying the at least two options, and highlighting the target option according to the option information of the at least two options.

After scanning the target two dimension code, the terminal acquires the option information stored in the target two dimension code. After the target option corresponding to the current scanning orientation is determined by the above steps, the terminal displays the at least two options, and highlights the target option according to the option information of the at least two options. Thus, a user can clearly know the option corresponding to the current scanning orientation. For example, when the orientation information is (−10, 0, 0), the target option can be determined to be the option B, as shown in FIG. 2b.

In specific implementations, in the process that the terminal scans the target two dimension code, when the scanning orientation of the terminal is changed by rotating the terminal, the target option which is need to be highlighted is updated in real time according to the scanning orientation of the terminal.

Step S205, outputting a content corresponding to the option information of the target option when receiving a confirmation instruction corresponding to the target option or when not receiving a confirmation instruction corresponding to any option in a preset duration.

After the terminal displays the at least two options, a user can click any one of the at least two options, in order to send a confirmation instruction for accessing the clicked option to the terminal. The terminal outputs the content corresponding to the option information of the target option when receiving the confirmation instruction corresponding to the target option. Of course, in specific implementations, the terminal can also output the content corresponding to the option information of the target option when not receiving a confirmation instruction corresponding to any option in the preset duration. For example, assuming that the current scanning orientation of the terminal corresponds to the option B and the preset duration is 10 milliseconds, after determining that the target option is the option B, the terminal automatically accesses the content corresponding to the target option when not receiving a confirmation instruction corresponding to any option in the following 10 milliseconds.

It should be noted that, in specific implementations, after determining the target option corresponding to the current scanning orientation, the terminal can also display the target option according to the option information of the target option, and output the content corresponding to the option information of the target option when receiving the confirmation instruction corresponding to the target option or when not receiving a confirmation instruction corresponding to the target option in the present duration, which is not limited in detail in this embodiment.

In order to facilitate understanding, taking a usage scenario where a two dimension code is used to store information of multiple contact persons as an example, assuming that the target two dimension code stores the information of 3 contact persons “San Zhang”, “Si Li”, and “Wu Wang”, in specific implementations, the information stored in the target two dimension code includes 3 options, and the option information of each option is the information (such as a name, a telephone number, an email address, etc.) of each contact person. After scanning the target two dimension code, the terminal firstly parses the option information of multiple options which is carried in the target two dimension code out of the target two dimension code, and then displays the multiple options on a terminal screen. Wherein, the target option corresponding to the current scanning orientation is highlighted, as shown in FIG. 2d, and FIG. 2d is a diagram of a scanning interface according to FIG. 2. In specific implementations, key information which is used to distinguish different options can be displayed, such as a name of each contact person (thus, a user can quickly find data that the user wants to access from a current interface). When receiving the confirmation instruction corresponding to the target option, or when not receiving a confirmation instruction corresponding to any option in the present duration, the terminal further outputs the option information of the target option, such as a name, a telephone number, an email address, etc.

In the two dimension code operating method described in this embodiment, when scanning a target two dimension code, a terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing this embodiment, when a user scans a two dimension code by use of a terminal, the terminal can output corresponding target contents according to scanning orientations of the terminal, which can improve operability of the two dimension code during operating.

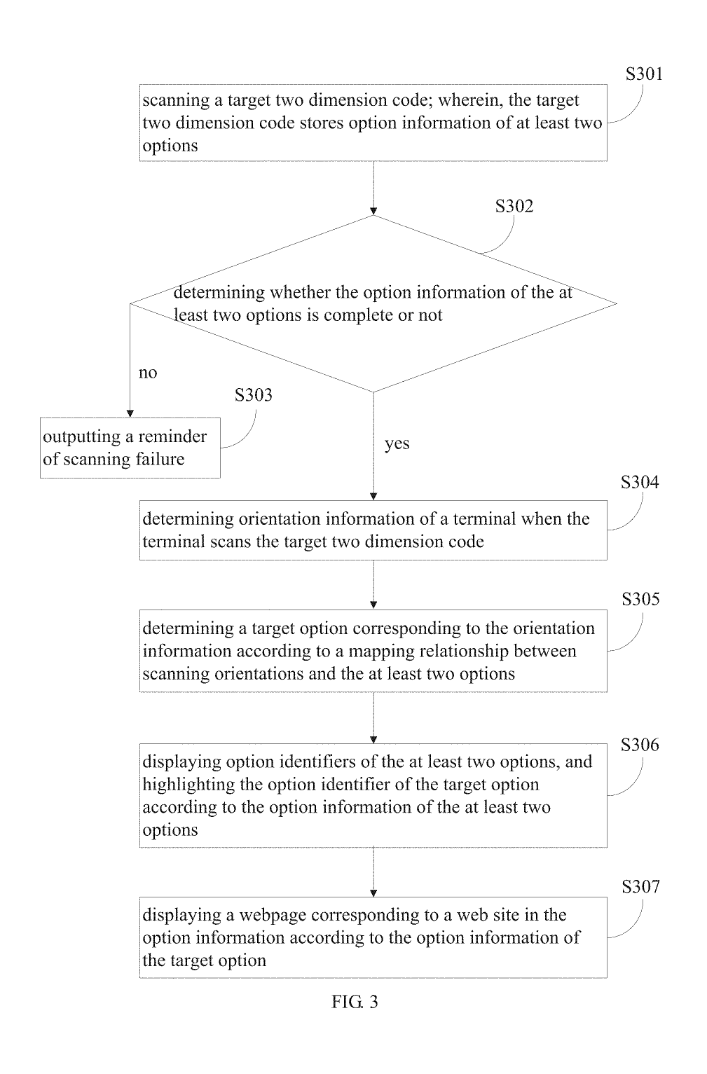

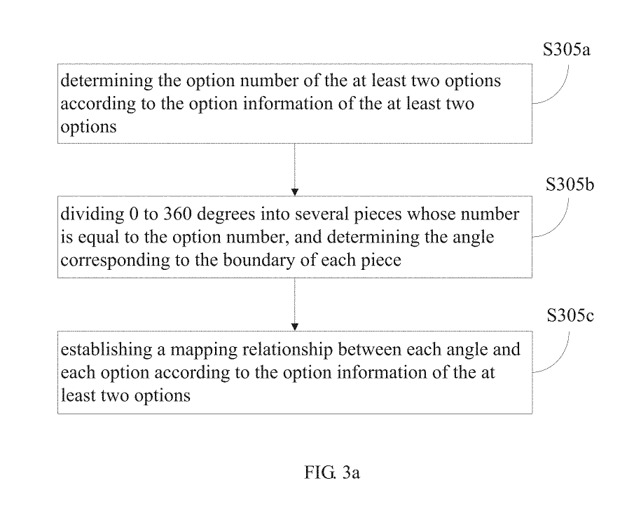

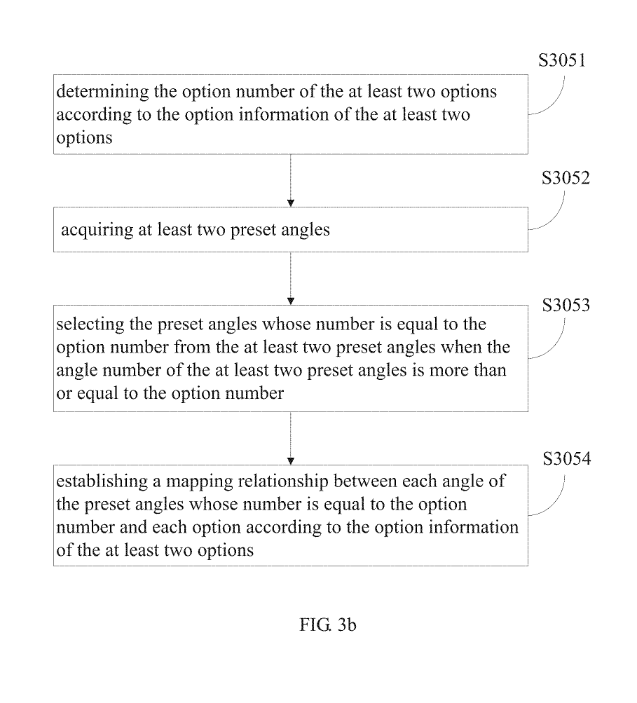

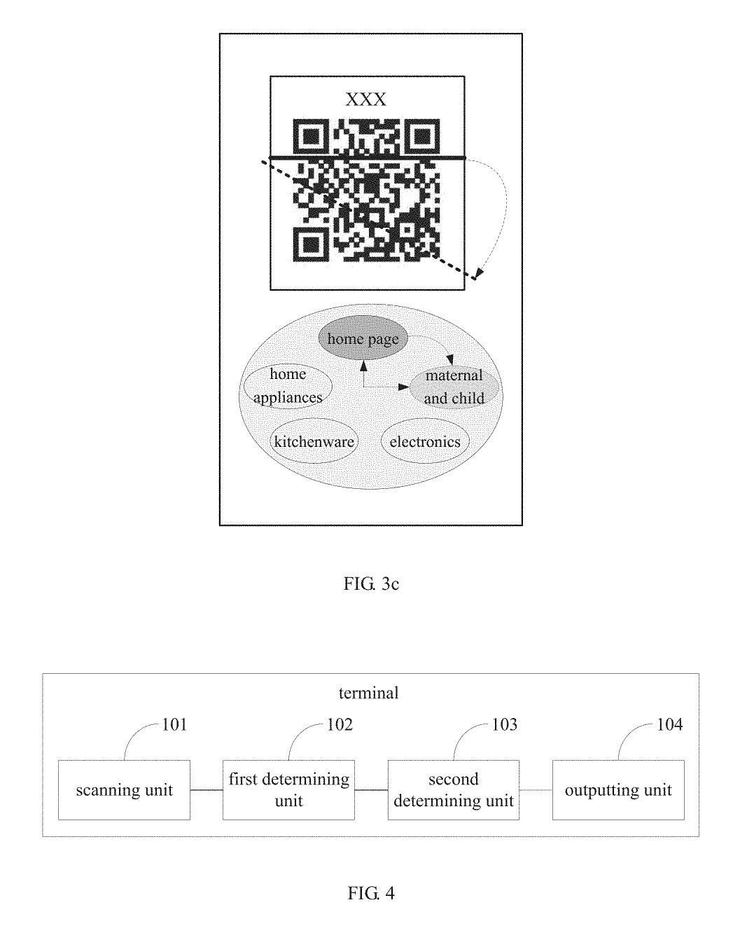

Referring to FIG. 3, FIG. 3 is a flowchart of a two dimension code operating method according to a third embodiment of the present disclosure. In this embodiment, the two dimension code operating method according to according to the third embodiment of the present disclosure may include the following steps.

Step S301, scanning a target two dimension code; wherein, the target two dimension code stores option information of at least two options.

In this embodiment, taking a usage scenario where a two dimension code is used to store web site information as a first example, in specific implementations, the option information may include option identifiers and web sites. Wherein, the option identifiers may be information such as web site classes. Taking a usage scenario that a two dimension code is used to store contact information as a second example, the option information may include option identifiers and contact information. Wherein, the option identifiers may be contact names or other information (for example, in a usage scenario where a two dimension code is used to store information of multiple contact persons, the option identifiers may be contact names; and in a usage scenario where a two dimension code is used to store information of a single contact person, the option identifiers may be a name, a telephone number, a title and other information of the contact person.). Taking a usage scenario that a two dimension code is used to store product information as a third example, the option information may include option identifiers and product information. Wherein, the option identifiers may be product names or other information (for example, in a usage scenario where a two dimension code is used to store information of multiple products, the option identifiers may be product names; and in a usage scenario that a two dimension code is used to store information of a single product, the option identifiers may be a name, a size, a model and other information of the product), which is not limited in detail in this embodiment.

In order to facilitate understanding, taking a shopping website as an example, assuming that the target two dimension code stores option information of 5 options and the 5 options are represented as home page, maternal and child, electronics, kitchenware and home appliances respectively, usually, each subclass, such as maternal and child, electronics, kitchenware or home appliances, etc., has a corresponding access portal in the home page. However, it is difficult for a user to quickly find a class that the user wants to access from the home page since the amount of information which is displayed in the home page is larger. In this embodiment, web site information which is accessed frequently is loaded in the target two dimension code, thus a user can quickly access a page that the user wants to access by scanning the target two dimension code. In specific implementations, a preset separator can be added between the option information of different options. In order to facilitate understanding, taking “&&” as an example of the preset separator, the information stored in the target two dimension code can be shown as follows:

home page http://www.taobao.com && maternal and child http://s.taobao.com/search?q=%C4%B8%D3%A4&js=1&stats_click=search_radio_all%253A1&initiative_id=staobaoz_20141107&& electronics http://s.taobao.com/search?q=%B5%E7%D7%D3&js=1&stats_click=search_radio_all %253A1&initiative_id=staobaoz_20141107&& kitchenware Http://s.taobao.com/search?q=%B3% F8%BE%DF&js=1&stats_click=search_radio_all%253A1&initiative_id=staobaoz_20141107&& home appliances http://s.taobao.com/search?q=%BC%D2%B5%E7&commend-all&ssid=s5-e&search_type=item&sourceld=tb.index&spm=1.7274553.1997520841.1&initiative_id=tbindexz_20141107.

Hence, after scanning the target two dimension code via a camera, the terminal can parses option information of the 5 options out of the option information stored in the target two dimension code. Wherein, the web site of the identifier “home page” is “http://www.taobao.com”; the web site of the identifier “maternal and child” is “http://s.taobao.com/search?q=%C4%B8%D3%A4&js=1&stats_click=search_radio_all %253A1&initiative_id=staobaoz_20141107”; the web site of the identifier “electronics” is “http://s.taobao.com/search?q=%B5%E7%D7% D3&js=1&stats_click=search_radio_all %253A1&initiative_id=staobaoz_20141107”; the web site of the identifier “kitchenware” is “http://s.taobao.com/search?q=%B3% F8% BE%DF&js=1&stats_click=search_radio_all %253A1&initiative_id=staobaoz_20141107”; and the web site of the identifier “home appliances” is “http://s.taobao.com/search?q=%BC%D2%B5%E7&commend=all&ssid=s5-e&search_type=item&sourceld=tb.index&spm=1.7274553.1997520841.1&initiative_id=tbindexz_20141107”.

Step S302, determining whether the option information of the at least two options is complete or not.

Usually, when scanned two dimension code is not complete or the image of the scanned two dimension code is blurred, a terminal cannot acquire complete two dimension code information. In this embodiment, the terminal scans the target two dimension code, and acquires the two dimension code information stored in the target two dimension code, and then determines whether the two dimension code information that is acquired by the terminal is complete or not. When the two dimension code information is complete, the terminal executes the step S304 for determining orientation information of a terminal when the terminal scans the target two dimension code; and when the two dimension code information is not complete, the terminal executes the step S303 for sending a reminder of scanning failure. The reminder can be displayed on a screen, or broadcasted through a loudspeaker. In specific implementations, after sending the reminder of scanning failure, the terminal can also acquire the two dimension code information again by rescanning the target two dimension code via the camera.

Step S303, outputting a reminder of scanning failure.

When determining that the two dimension code information which is acquired by the terminal is not complete, the reminder of scanning failure is output, in order to remind a user to scan the target two dimension code again by re-aiming the terminal at the target two dimension code.

Step S304, determining orientation information of a terminal when the terminal scans the target two dimension code.

When determining that the two dimension code information which is acquired by the terminal is complete, the orientation information of the terminal when the terminal scans the target two dimension code is determined. Wherein, specific details for acquiring the orientation information can be seen by reference to the above embodiments, so it is unnecessary to go into details here. But in order to facilitate understanding, a slant angle of the terminal when the terminal scans the target two dimension code is taken here as an example of the orientation information in this embodiment.

Step S305, determining a target option corresponding to the orientation information according to a mapping relationship between scanning orientations and the at least two options.

In specific implementations, the mapping relationship between the scanning orientations and the options can be stored in the target two dimension code. After scanning the target two dimension code, the terminal can parse the mapping relationship out of the target two dimension code. Of course, the mapping relationship can also be built according to a preset rule after the terminal scans the target two dimension code, which is not limited in detail in this embodiment, but the latter way for establishing the mapping relationship is a preferred implementation way.

As an example, after acquiring the option information stored in the target two dimension code via the camera, the terminal establishes the mapping relationship between the scanning orientations and the options, as shown in FIG. 3a, and FIG. 3a is a flowchart of a first method to for establishing a mapping relationship according to the third embodiment as shown in FIG. 3 of the present disclosure. The first method for establishing a mapping relationship according to the third embodiment as shown in FIG. 3 of the present disclosure may include the steps S305a to S305c.

Step S305a, determining the option number of the at least two options according to the option information of the at least two options.

In specific implementations, the terminal can determines the option information of each option according to a preset separator between the option information of the at least two options, in order to determine the option number of the at least two options stored in the target two dimension code.

Step S305b, dividing 0 to 360 degrees into several pieces whose number is equal to the option number, and determining the angle corresponding to the boundary of each piece.

A way for dividing 0 to 360 degrees into the several pieces whose number is equal to the option number according to the preset rule, in specific implementations, may be to evenly divide 0 to 360 degrees, or to divide 0 to 360 degrees in different proportions, which is not limited in this embodiment. After the several pieces whose number is equal to the option number are acquired, the angle corresponding to the boundary of each piece is determined.

In order to facilitate understanding, assuming that the option number is 4 and the preset rule is to evenly divide 0 to 360 degrees. Then after 0 to 360 degrees are divided into 4 equal pieces, acquired boundary angles are 0 degree, 90 degrees, 180 degrees and 270 degrees respectively. Assuming that the option number is 2 and the preset rule is to evenly divide 0 to 360 degrees. Then after 0 to 360 degrees are divided into 2 equal pieces, acquired boundary angles are 0 degree and 180 degrees respectively. In specific implementations, the angles that are to be divided may also be represented as −180 to 180 degrees.

Step S305c, establishing a mapping relationship between each angle and each option according to the option information of the at least two options.

After preset angles whose number is equal to the option number are acquired, the mapping relationship between each angle and each option is built according to the option information of the at least two options stored in the target two dimension code. For example, the mapping relationship between each angle and each option is built in turn according to a sequence of the option information of the at least two options. In specific implementations, the mapping relationship between the options and the angles can be set according to users' requirements. After the mapping relationship between each angle and each option is determined, the mapping relationship can be embedded on a display interface in the scanning process. For example, it can be embedded on the display interface that the target option changes with the scanning orientation.

It should be noted that, in specific implementations, the mapping relationship where 2 angles correspond to 1 option or much more angles correspond to 1 option can also be taken into consideration. For example, when two options corresponding to 2 complementary angles respectively are the same, assuming that the option number is 2 and the 2 options are identified as option A and option B respectively, after −180 to 180 degrees are divided into 4 equal pieces, the mapping relationship can be represented as: 0 degree and 180 degrees correspond to the option A, and 90 degrees and −90 degrees correspond to the option B.

As another example, after acquiring the option information stored in the target two dimension code via the camera, the terminal establishes a mapping relationship between the scanning orientations and the options, as shown in FIG. 3b, and FIG. 3b is a flowchart of a second method for establishing a mapping relationship according to the third embodiment as shown in FIG. 3 of the present disclosure. The second method for establishing a mapping relationship according to the third embodiment as shown in FIG. 3 of the present disclosure may include the steps S3051 to S3054.

Step S3051, determining the option number of the at least two options according to the option information of the at least two options.

In specific implementations, some angles can be preset in the terminal for some typical scanning orientations. For example, the preset angles may include 0 degree, 45 degrees, 90 degrees, 135 degrees and 180 degrees, etc.

Step S3052, acquiring at least two preset angles.

Step S3053, selecting the preset angles whose number is equal to the option number from the at least two preset angles when the angle number of the at least two preset angles is more than or equal to the option number.

When the angle number of the at least two preset angles is more than or equal to the option number, the preset angles whose number is equal to the option number are selected from the at least two preset angles. For example, assuming that there are 5 preset angles and the option number is 4, 4 angles can be arbitrarily selected from the 5 preset angles.

Step S3054, establishing a mapping relationship between each angle of the preset angles whose number is equal to the option number and each option according to the option information of the at least two options.

For example, the mapping relationship between each option and each selected angle is built in turn according to a sequence of the option information of the at least two options. In specific implementations, the mapping relationship between the options and the angles can be set according to users' requirements. After the mapping relationship between each angle and each option is determined, the mapping relationship can be embedded on a display interface in the scanning process. For example, it can be embedded on the display interface that the target option changes with the scanning orientation. Therefore, when the mapping relationship between the scanning orientations and the options is acquired after the target two dimension code is scanned, the target option can be determined according to the orientation information of the terminal when the terminal scans the target two dimension code.

Step S306, displaying option identifiers of the at least two options, and highlighting the option identifier of the target option according to the option information of the at least two options.

In specific implementations, the terminal can determines the option information of each option according to a preset separator between the option information of the at least two options stored in the target two dimension code. Wherein, the option information includes option identifiers and web sites, and there is a one-to-one correspondence between the option identifiers and the web sites. In addition, the terminal establishes an association relationship between an option identifier and a web site of each option, and displays the option identifiers of the at least two options and highlights the option identifier of the target option.

For example, when the option information is option identifiers and contact information, the terminal can determines the option information of each option according to a preset separator between the option information of the at least two options stored in the target two dimension code. Wherein, the option information includes option identifiers and contact information, and there is a one-to-one correspondence between the option identifiers and the contact information. In addition, the terminal establishes an association relationship between an option identifier and contact information of each option, and displays the option identifiers of the at least two options and highlights the option identifier of the target option.

For another example, when the option information is option identifiers and product information, the terminal can determines the option information of each option according to a preset separator between the option information of the at least two options stored in the target two dimension code. Wherein, the option information includes option identifiers and product information, and there is a one-to-one correspondence between the option identifiers and the product information. In addition, the terminal establishes an association relationship between an option identifier and product information of each option, and displays the option identifiers of the at least two options and highlights the option identifier of the target option.

In order to facilitate understanding, the example in the step S301 is used here to illustrate this step. It should be known that, the target two dimension code stores option information of 5 options, and option identifiers of the 5 options are “home page”, “maternal and child”, “electronics”, “kitchenware” and “home appliances” respectively. A mapping relationship which is built according to the above description can be shown in Tab. 2, and Tab. 2 is a chart of a mapping relationship according to FIG. 3.

TABLE 2

| slant angles | | options |
|---|---|---|
| 0 | degree | home page |
| 45 | degrees | maternal and child |
| 90 | degrees | electronics |
| 180 | degrees | kitchenware |
| 270 | degrees | home appliances |

In order to facilitate understanding, assuming that the scanning orientation of the terminal when the terminal scans the target two dimension code is shown as FIG. 3c, and FIG. 3c is a diagram of a scanning orientation according to FIG. 3. It should be known that, when the slant angle corresponding to the current scanning orientation is 0 degree, the target option is determined to be the option “home page” according to Tab. 2. Hence, a displaying result of the options is shown as FIG. 3c. In FIG. 3c, the target option “home page” is highlighted, in order to remind a user that the option corresponding to the current scanning orientation is the option “home page”. In specific implementations, when the terminal moves above the target two dimension code, correspondingly, the orientation information between the terminal and the target two dimension code also changes. Therefore, the target option can be updated in real time according to acquired orientation information. For example, for the scanning orientation as shown in FIG. 3c, when the terminal is rotated to right, as shown by the dotted line in FIG. 3c, the target option can be changed from the option “home page” to the option “maternal and child”. The changing processes are marked in a displaying box in real time, thus interestingness is improved.

Step S307, displaying a webpage corresponding to a web site in the option information according to the option information of the target option.

For an example, when receiving a confirmation instruction corresponding to the target option or when not receiving a confirmation instruction corresponding to any option in a present duration, according to the web site in the option information of the target option, the webpage corresponding to the web site is displayed. For another example, when the option information includes option identifiers and contact information, the contact information corresponding to the target option is displayed; and when the option information includes option identifiers and product information, the product information corresponding to the target option is displayed.

In the two dimension code operating method described in this embodiment, when scanning a target two dimension code, a terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing this embodiment, when a user scans a two dimension code by use of a terminal, the terminal can output corresponding target contents according to scanning orientations of the terminal, which can improve operability of the two dimension code during operating.

Device embodiments of the present disclosure will now be described in detail. The device embodiments of the present disclosure has the same conception with method embodiments of the present disclosure, and is used to execute the methods described in the method embodiments of the present disclosure. In order to facilitate understanding, the device embodiments of the present disclosure only illustrate the parts that are related to the device embodiments of the present disclosure. Specific details that are not revealed in the device embodiments of the present disclosure can be seen by reference to the descriptions in the method embodiments of the present disclosure, so it is unnecessary to go into details here.

Referring to FIG. 4, FIG. 4 is a block diagram of a terminal according to a first embodiment of the present disclosure. In this embodiment, the terminal according to the first embodiment of the present disclosure may include: a scanning unit 101, a first determining unit 102, a second determining unit 103 and an outputting unit 104.

The scanning unit 101 is used to scan a target two dimension code. Wherein, the target two dimension code stores option information of at least two options.

With the development of two dimension code technology, the capacity of a two dimension code for storing data gets larger and larger. However, this advantage of the two dimension code for storing larger data is not fully realized. According to current two dimension code scanning methods, no matter what kind of orientation a terminal uses to scan a two dimension code, the way for displaying information is single after the terminal scans the two dimension code.

In this embodiment, the option information of the at least two options can be stored previously in a two dimension code. When a terminal scans the two dimension code, different options are accessed according to scanning orientations, which enriches the way for scanning the two dimension code. For example, the option information may include web sites and/or web site themes, text information, etc., which is not limited in detail in this embodiment. In specific implementations, a terminal scans the target two dimension code, and the target two dimension code stores the option information of the at least two options.

In order to facilitate understanding, taking a shopping website as a first example, the option information may be a web site corresponding to any information in the shopping website and/or an identifier of the any information, such as the web site corresponding to the home page of the shopping website and the identifier “home page”, the web site corresponding to information of electronic products in the shopping website and the identifier “electronics”, or the web site corresponding to information of cosmetics and the identifier “cosmetics”, etc. In addition, a usage scenario of a business card is taken here as a second example. Usually, the business card includes information such as a name, a telephone number, an email address and a title, etc., and the information can be considered as the option information described in this embodiment. Moreover, taking an address book as a third example, part or whole of contact information can be integrated in a two dimension code, thus the option information may include a name, a telephone number and other information of each contact person. Furthermore, taking electronic business as a fourth example, parameter information of some electronic products can be integrated in a two dimension code. In order to facilitate illustrating, taking a television as an example of the electronic products, the parameter information of the television may include color, size, resolution ratio, screen ratio, a brand and other information, and can be considered as the option information described in this embodiment In specific implementations, the option information can be set according to users' requirements, which is no longer enumerated one by one in this embodiment.

The first determining unit 102 is used to determine orientation information of the terminal when the terminal scans the target two dimension code.

In specific implementations, the orientation information may be a scanning orientation of the terminal itself. Usually, the orientation information can be obtained via sensor data which is acquired by use of an orientation sensor. Wherein, the orientation sensor may be a gravity sensor, a gyroscope, a geomagnetic sensor, an acceleration sensor, an angular velocity sensor or an inclinometer, etc., which is not limited in detail in this embodiment. Of course, the orientation information may also be a slant angle between the terminal and the target two dimension code, which is not limited in detail in this embodiment.

In specific implementations, the orientation information may be a scanning orientation of the terminal itself. Usually, the orientation information can be obtained via sensor data which is acquired by use of an orientation sensor. Wherein, the orientation sensor may be a G-sensor, a gyroscope, a geomagnetic sensor, an acceleration sensor, an angular velocity sensor or an inclinometer, etc., which is not limited in detail in this embodiment. For example, when a mobile phone scans the target two dimension code while the mobile phone is placed horizontally, G-sensor data (x, y, z) is equal to (0, 0, 10); when a mobile phone scans the target two dimension code while the mobile phone is placed vertically, G-sensor data (x, y, z) is equal to (0, 10, 0); when a mobile phone scans the target two dimension code while the mobile phone is laid to right, G-sensor data (x, y, z) is equal to (−10, 0, 0); and when a mobile phone scans the target two dimension code while the mobile phone is laid to left, G-sensor data (x, y, z) is equal to (10, 0, 0).

The second determining unit 103 is used to determine a target option corresponding to the orientation information according to a mapping relationship between scanning orientations and the at least two options.

In specific implementations, after scanning the target two dimension code, the terminal can acquire the option information of the at least two options stored in the target two dimension code, in order to determine specific option number, and establish the mapping relationship between the scanning orientations and the at least two options according to a preset rule, in order to determine the target option corresponding to the orientation information.

In order to facilitate understanding, taking the slant angle described above as an example of the orientation information, assuming that the option number of the option information stored in the two dimension code is obtained to be 4 and the 4 options are identified as A, B, C and D respectively. A mapping relationship between the scanning orientations and the 4 options can be shown in Tab. 1 mentioned above. According to Tab. 1, it can be known that, when the slant angle between the terminal and the target two dimension code is 0 degree, the target option corresponding to a current scanning orientation of the terminal is determined to be the option A; when the slant angle between the terminal and the target two dimension code is 90 degrees, the target option corresponding to a current scanning orientation of the terminal is determined to be the option B; when the slant angle between the terminal and the target two dimension code is 180 degrees, the target option corresponding to a current scanning orientation of the terminal is determined to be the option C; and when the slant angle between the terminal and the target two dimension code is 270 degrees, the target option corresponding to a current scanning orientation of the terminal is determined to be the option D. It should be noted that, the mapping relationship as shown in Tab. 1 is just an example. In specific implementations, the mapping relationship between the scanning orientations and the options can be set according to actual requirements, which is not limited in this embodiment.

In order to facilitate understanding, a usage scenario where the orientation information of the terminal is acquired by use of a gravity sensor is taken here as an example. After scanning the target two dimension code, the terminal acquires the option information stored in the target two dimension code. Assuming that the target two dimension code stores option information of 3 options and the 3 options are identified as A, B and C respectively. A mapping relationship between scanning orientations and the 3 options is built according to a preset rule. In order to facilitate understanding, assuming that G-sensor data (0, 0, 10) or (0, 10, 0) corresponds to the option A, as shown in FIG. 2a; G-sensor data (−10, 0, 0) corresponds to the option B, as shown in FIG. 2b; and G-sensor data (10, 0, 0) corresponds to the option C, as shown in FIG. 2c. Hence, if the orientation information of the terminal when the terminal scans the target two dimension code is (−10, 0, 0), the target option can be determined to be the option B, as shown in FIG. 2b. It should be noted that, the above description is just an example.

The outputting unit 104 is used to output a content corresponding to the option information of the target option.

After the target option corresponding to the current scanning orientation of the terminal is determined by the above units, according to the option information of the target option, the content corresponding to the option information is output. Therefore, a user can access different option contents via different scanning orientations, which can enrich the ways for scanning a two dimension code and displaying information. At the same time, the user can quickly access a content that the user wants to access according to the user's requirements, and efficiency of scanning the two dimension code is high, thus operability of the two dimension code during operating can be improved. Taking a usage scenario where the two dimension code is used to store web site information as a first example, the option information may include option identifiers and web sites. Then, according to the web site corresponding to the target option in the option information, a webpage corresponding to the target option is output. In addition, taking a usage scenario where the two dimension code is used to store contact information as a second example, the option information may include option identifiers and contact information. Then, according to the contact information corresponding to the target option in the option information, the contact information corresponding to the target option is output. Moreover, taking a usage scenario where the two dimension code is used to store product information as a third example, the option information may include option identifiers and product information. Then, according to the product information corresponding to the target option in the option information, the product information corresponding to the target option is output. In specific implementations, the output content is related to an actual usage scenario, which is not limited in this embodiment.

In the terminal described in this embodiment, when scanning a target two dimension code, the terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing this embodiment, when a user scans a two dimension code by use of the terminal, the terminal can output corresponding target contents according to scanning orientations of the terminal, which can improve operability of the two dimension code during operating.

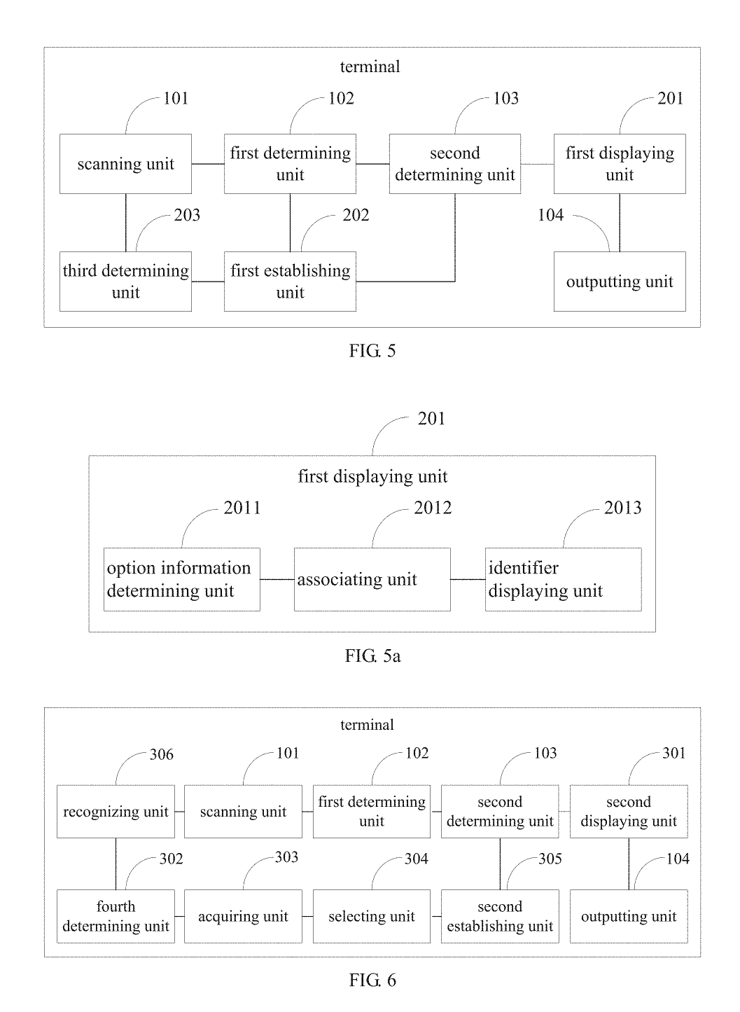

Referring to FIG. 5, FIG. 5 is a block diagram of a terminal according to a second embodiment of the present disclosure. In this embodiment, besides the scanning unit 101, the first determining unit 102, the second determining unit 103 and the outputting unit 104, the terminal according to the second embodiment of the present disclosure may also include: a first displaying unit 201, a first establishing unit 202 and a third determining unit 203.

The first displaying unit 201 is used to display the at least two options, and highlight the target option according to the option information of the at least two options.

After scanning the target two dimension code, the terminal acquires the option information stored in the target two dimension code. After the target option corresponding to the current scanning orientation is determined by the above steps, the terminal displays the at least two options, and highlights the target option according to the option information of the at least two options. Thus, a user can clearly know the option corresponding to the current scanning orientation. For example, when the orientation information is (−10, 0, 0), the target option can be determined to be the option B, as shown in FIG. 2b.

In specific implementations, in the process that the terminal scans the target two dimension code, when the scanning orientation of the terminal is changed by rotating the terminal, the target option which is need to be highlighted is updated in real time according to the scanning orientation of the terminal.

In an implementation way, in detail, the outputting unit 104 is used to output a content corresponding to the option information of the target option when receiving a confirmation instruction corresponding to the target option or when not receiving a confirmation instruction corresponding to any option in a preset duration.

After the terminal displays the at least two options, a user can click any one of the at least two options, in order to send a confirmation instruction for accessing the clicked option to the terminal. The terminal outputs the content corresponding to the option information of the target option when receiving the confirmation instruction corresponding to the target option. Of course, in specific implementations, the terminal can also output the content corresponding to the option information of the target option when not receiving a confirmation instruction corresponding to any option in the preset duration. For example, assuming that the current scanning orientation of the terminal corresponds to the option B and the preset duration is 10 milliseconds, after determining that the target option is the option B, the terminal automatically accesses the content corresponding to the target option when not receiving a confirmation instruction corresponding to any option in the following 10 milliseconds.

In an implementation way, the orientation information includes the slant angle between the terminal and the target two dimension code. The third determining unit 203 is used to determine the option number of the at least two options according to the option information of the at least two options, and divide 0 to 360 degrees into several pieces whose number is equal to the option number and determine the angle corresponding to the boundary of each piece. The first establishing unit 202 is used to establish a mapping relationship between each angle and each option according to the option information of the at least two options.

In specific implementations, the terminal can determines the option information of each option according to a preset separator between the option information of the at least two options, in order to determine the option number of the at least two options stored in the target two dimension code. A way for dividing 0 to 360 degrees into the several pieces whose number is equal to the option number according to the preset rule, in specific implementations, may be to evenly divide 0 to 360 degrees, or to divide 0 to 360 degrees in different proportions, which is not limited in this embodiment. After the several pieces whose number is equal to the option number are acquired, the angle corresponding to the boundary of each piece is determined. In order to facilitate understanding, assuming that the option number is 4 and the preset rule is to evenly divide 0 to 360 degrees. Then after 0 to 360 degrees are divided into 4 equal pieces, acquired boundary angles are 0 degree, 90 degrees, 180 degrees and 270 degrees respectively. Assuming that the option number is 2 and the preset rule is to evenly divide 0 to 360 degrees. Then after 0 to 360 degrees are divided into 2 equal pieces, acquired boundary angles are 0 degree and 180 degrees respectively. In specific implementations, the angles that are to be divided may also be represented as −180 to 180 degrees.

After preset angles whose number is equal to the option number are acquired, the mapping relationship between each angle and each option is built according to the option information of the at least two options stored in the target two dimension code. For example, the mapping relationship between each angle and each option is built in turn according to a sequence of the option information of the at least two options. In specific implementations, the mapping relationship between the options and the angles can be set according to users' requirements. After the mapping relationship between each angle and each option is determined, the mapping relationship can be embedded on a display interface in the scanning process. For example, it can be embedded on the display interface that the target option changes with the scanning orientation.

It should be noted that, in specific implementations, the mapping relationship where 2 angles correspond to 1 option or much more angles correspond to 1 option can also be taken into consideration. For example, when two options corresponding to 2 complementary angles respectively are the same, assuming that the option number is 2 and the 2 options are identified as option A and option B respectively, after −180 to 180 degrees are divided into 4 equal pieces, the mapping relationship can be represented as: 0 degree and 180 degrees correspond to the option A, and 90 degrees and −90 degrees correspond to the option B.

In an implementation way, in detail, the first determining unit 102 is used to: determine a direction of a scanning line of the terminal when the terminal scans the target two dimension code, determine a direction of a horizontal line corresponding to a current position of the target two dimension code according to a location detecting graph and a positioning graph of the target two dimension code, and determine the slant angle between the terminal and the target two dimension code according to the direction of the horizontal line and the direction of the scanning line.

Usually, from users' perspective, the direction of the scanning line is a horizontal direction which is parallel to the upper edge of the terminal and is from left to right, and the direction of the horizontal line of the target two dimension code is usually a horizontal direction which is parallel to the upper edge of the target two dimension code and is from left to right. In order to facilitate understanding, referring to FIG. 1b, it should be known that, according to the scanning orientation shown in FIG. 1b, the direction of the scanning line of the terminal when the terminal scans the target two dimension code is “the direction of the scanning line” as shown in FIG. 1b, and the direction of the horizontal line of the target two dimension code is “the direction of the horizontal line” as shown in FIG. 1b. For another example, referring to FIG. 1c, it should be known that, according to the scanning orientation shown in FIG. 1c, the direction of the scanning line of the terminal when the terminal scans the target two dimension code is “the direction of the scanning line” as shown in FIG. 1c, and the direction of the horizontal line of the target two dimension code is “the direction of the horizontal line” as shown in FIG. 1c. After the direction of the scanning line when the terminal scans the target two dimension code and the direction of the horizontal line corresponding to the current position of the target two dimension code are determined, the slant angle between the terminal and the target two dimension code can be determined according to direction of the scanning line and determined direction of the horizontal line. In order to facilitate understanding, for example, according to the scanning orientation as shown in FIG. 1b, the slant angle between the terminal and the target two dimension code can be determined to be 45 degrees. For another example, according to the scanning orientation as shown in FIG. 1c, the slant angle between the terminal and the target two dimension code can be determined to be 90 degrees.

It should be noted that, in specific implementations, the slant angle between the terminal and the target two dimension code can also be obtained by other ways, which is not limited in detail in this embodiment.

In an implementation way, in detail, the first determining unit 102 is used to acquire the orientation information of the terminal when the terminal scans the target two dimension code by use of a gravity sensor, a gyroscope or a geomagnetic sensor.

In a first implementation way, the option information includes option identifiers and web sites. The first displaying unit 201 is used to display option identifiers of the at least two options, and highlight the option identifier of the target option according to the option information of the at least two options. The outputting unit 104 is used to display a webpage corresponding to a web site in the option information according to the option information of the target option.

In a second implementation way, the option information includes option identifiers and contact information. The first displaying unit 201 is used to display option identifiers of the at least two options, and highlight the option identifier of the target option according to the option information of the at least two options. The outputting unit 104 is used to display the contact information corresponding to the option information according to the option information of the target option.

In a third implementation way, the option information includes option identifiers and product information. The first displaying unit 201 is used to display option identifiers of the at least two options, and highlight the option identifier of the target option according to the option information of the at least two options. The outputting unit 104 is used to display the product information corresponding to the option information according to the option information of the target option.

In an implementation way, the first displaying unit 201 may include: an option information determining unit 2011, an associating unit 2012 and an identifier displaying unit 2013, as shown in FIG. 5a. FIG. 5a is a block diagram of a first displaying unit as shown in FIG. 5.

The option information determining unit 2011 is used to determine the option information of each option according to a preset separator between the option information of the at least two options stored in the target two dimension code. The associating unit 2012 is used to establish an association relationship between an option identifier and a web site of each option. The identifier displaying unit 2013 is used to display the option identifiers of the at least two options and highlight the option identifier of the target option.

In order to facilitate understanding, taking a usage scenario where a two dimension code is used to store information of multiple contact persons as an example, assuming that the target two dimension code stores the information of 3 contact persons “San Zhang”, “Si Li”, and “Wu Wang”, in specific implementations, the information stored in the target two dimension code includes 3 options, and the option information of each option is the information (such as a name, a telephone number, an email address, etc.) of each contact person. After scanning the target two dimension code, the terminal firstly parses the option information of multiple options which is carried in the target two dimension code out of the target two dimension code, and then displays the multiple options on a terminal screen. Wherein, the target option corresponding to the current scanning orientation is highlighted, as shown in FIG. 2d, and FIG. 2d is a diagram of a scanning interface according to FIG. 2. In specific implementations, key information which is used to distinguish different options can be displayed, such as a name of each contact person (thus, a user can quickly find data that the user wants to access from a current interface). When receiving the confirmation instruction corresponding to the target option, or when not receiving a confirmation instruction corresponding to any option in the present duration, the terminal further outputs the option information of the target option, such as a name, a telephone number, an email address, etc.

In the terminal described in this embodiment, when scanning a target two dimension code, the terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing this embodiment, when a user scans a two dimension code by use of the terminal, the terminal can output corresponding target contents according to scanning orientations of the terminal, which can improve operability of the two dimension code during operating.

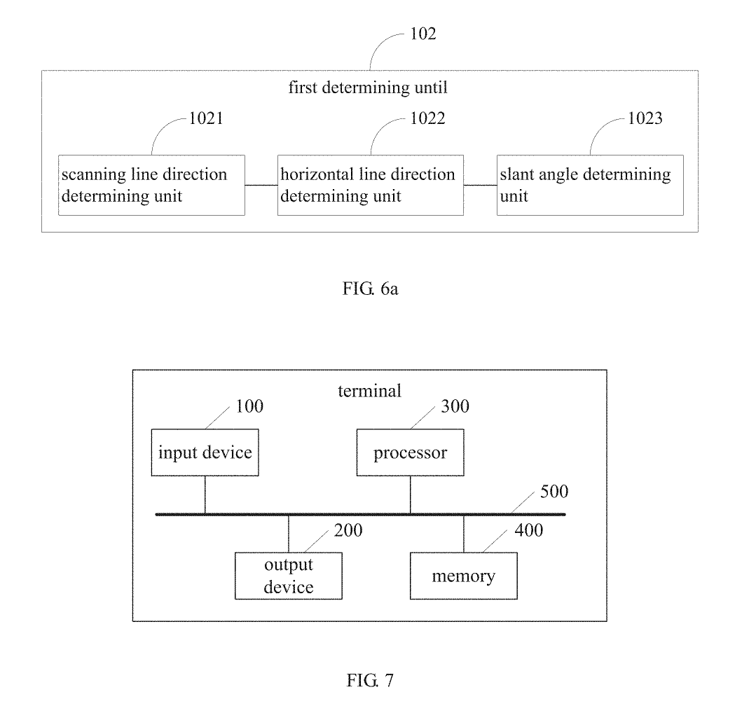

Referring to FIG. 6, FIG. 6 is a block diagram of a terminal according to a third embodiment of the present disclosure. In this embodiment, besides the scanning unit 101, the first determining unit 102, the second determining unit 103 and the outputting unit 104, the terminal according to the third embodiment of the present disclosure may also include: a second displaying unit 301, a fourth determining unit 302, an acquiring unit 303, a selecting unit 304, a second establishing unit 305 and a recognizing unit 306.

The second displaying unit 301 is used to display the target option according to the option information of the at least two options.

In an implementation way, in detail, the outputting unit 104 is used to output a content corresponding to the option information of the target option when receiving a confirmation instruction corresponding to the target option or when not receiving a confirmation instruction corresponding to the target option in a preset duration.

The fourth determining unit 302 is used to determine the option number of the at least two options according to the option information of the at least two options. The acquiring unit 303 is used to acquire at least two preset angles. The selecting unit 304 is used to select the preset angles whose number is equal to the option number from the at least two preset angles when the angle number of the at least two preset angles is more than or equal to the option number. The second establishing unit 305 is used to establish a mapping relationship between each angle of the preset angles whose number is equal to the option number and each option according to the option information of the at least two options. For example, the mapping relationship between each option and each selected angles is built in turn according to a sequence of the option information of the at least two options. In specific implementations, the mapping relationship between the options and the angles can be set according to the preset. After the mapping relationship between each angle and each option is determined, the mapping relationship can be embedded on a display interface in the scanning process. For example, it can be embedded on the display interface that the target option changes with the scanning orientation.

In specific implementations, some angles can be preset in the terminal for some typical scanning orientations. For example, the preset angles may include 0 degree, 45 degrees, 90 degrees, 135 degrees and 180 degrees, etc. When the angle number of the at least two preset angles is more than or equal to the option number, the preset angles whose number is equal to the option number are selected from the at least two preset angles. For example, assuming that there are 5 preset angles and the option number is 4, 4 angles can be arbitrarily selected from the 5 preset angles. A mapping relationship between each angle of the preset angles whose number is equal to the option number and each option is built according to the option information of the at least two options. Therefore, when the mapping relationship between the scanning orientations and the options is acquired after the target two dimension code is scanned, the target option can be determined according to the orientation information of the terminal when the terminal scans the target two dimension code.

In an implementation way, the first determining until 102 may include a scanning line direction determining unit 1021, a horizontal line direction determining unit 1022 and a slant angle determining unit 1023, as shown in FIG. 6a, and FIG. 6a is a block diagram of a first determining unit as shown in FIG. 6.

The scanning line direction determining unit 1021 is used to determine a direction of a scanning line of the terminal when the terminal scans the target two dimension code. The horizontal line direction determining unit 1022 is used to determine a direction of a horizontal line corresponding to a current position of the target two dimension code according to a location detecting graph and a positioning graph of the target two dimension code. The slant angle determining unit 1023 is used to determine a slant angle between the terminal and the target two dimension code according to the direction of the horizontal line and the direction of the scanning line.

In an implementation way, in detail, the first determining until 102 is used to acquire the orientation information of the terminal when the terminal scans the target two dimension code by use of a gravity sensor, a gyroscope or a geomagnetic sensor.

In an implementation way, the recognizing unit 306 is used to determine whether the option information of the at least two options is complete or not. In detail, the first determining until 102 is used to determine the orientation information of the terminal when the terminal scans the target two dimension code when the option information of the at least two options is complete; and the outputting unit 104 is used to output a reminder of scanning failure when the option information of the at least two options is not complete.

Usually, when scanned two dimension code is not complete or the image of the scanned two dimension code is blurred, a terminal cannot acquire complete two dimension code information. In this embodiment, the terminal scans the target two dimension code, and acquires the two dimension code information stored in the target two dimension code, and then determines whether the two dimension code information that is acquired by the terminal is complete or not. When the two dimension code information is complete, the terminal executes for determining orientation information of the terminal; and when the two dimension code information is not complete, the terminal executes for sending a reminder of scanning failure. The reminder can be displayed on a screen, or broadcasted through a loudspeaker. In specific implementations, after sending the reminder of scanning failure, the terminal can also acquire the two dimension code information again by rescanning the target two dimension code via the camera.

In the terminal described in this embodiment, when scanning a target two dimension code, the terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing this embodiment, when a user scans a two dimension code by use of the terminal, the terminal can output corresponding target contents according to scanning orientations of the terminal, which can improve operability of the two dimension code during operating.

Referring to FIG. 7, FIG. 7 is a block diagram of a terminal according to a fourth embodiment of the present disclosure. The terminal according to the fourth embodiment of the present disclosure may include: at least one input device 100, at least one output device 200, at least one processor 300, such as a central processing unit (CPU), and a memory 400. The input device 100, the output device 200, the processor 300 and the memory 400 are connected via a bus 500.

Wherein, the input device 100 may include a touch panel and a camera. The touch panel may be a touch screen, and is used to detect operating instructions (such as a confirmation instruction corresponding to a target option) on the touch panel. The camera is used to scan a two dimension code, so that image information of a target two dimension code can be acquired by the camera.

The output device 200 may be a display screen in detail, and is used to output and display data information (such as options stored in a target two dimension code, a content corresponding to a target option, etc.) need to be displayed after a two dimension code is scanned.

The memory 400 may be a high-speed random access memory (RAM), or a non-volatile memory, such as a disk memory. The memory 400 is used to store a group of program codes, and the input device 100, output device 200 and processor 300 are used to call the program codes stored in the memory 400 to execute the following operations.

The input device 100 is used to scan a target two dimension code. Wherein, the target two dimension code stores option information of at least two options.

The processor 300 is used to determine orientation information of a terminal when the terminal scans the target two dimension code.

The processor 300 is used to determine a target option corresponding to the orientation information according to a mapping relationship between scanning orientations and the at least two options.

The output device 200 is used to output a content corresponding to option information of the target option.

In some feasible implementation ways, before outputting a content corresponding to option information of the target option, the output device 200 further executes for:

displaying the at least two options, and highlighting the target option according to the option information of the at least two options; and

the output device 200 outputs the content corresponding to the option information of the target option when the processor 300 receives a confirmation instruction corresponding to the target option, or when not receiving a confirmation instruction corresponding to any option in a preset duration.

In some feasible implementation ways, before outputting a content corresponding to option information of the target option, the output device 200 further executes for:

displaying the target option according to the option information of the target option; and

the output device 200 outputs the content corresponding to the option information of the target option when the processor 300 receives a confirmation instruction corresponding to the target option, or when not receiving a confirmation instruction corresponding to the target option in a preset duration.

In some feasible implementation ways, the orientation information includes a slant angle between the terminal and the target two dimension code. After the input device 100 scans the target two dimension code, the processor 300 further executes for

determining the option number of the at least two options according to the option information of the at least two options;

dividing 0 to 360 degrees into several pieces whose number is equal to the option number, and determining the angle corresponding to the boundary of each piece; and

establishing a mapping relationship between each angle and each option according to the option information of the at least two options.

In some feasible implementation ways, the orientation information includes a slant angle between the terminal and the target two dimension code. After the input device 100 scans the target two dimension code, the processor 300 further executes for:

determining the option number of the at least two options according to the option information of the at least two options;

acquiring at least two preset angles;

selecting the preset angles whose number is equal to the option number from the at least two preset angles when the angle number of the at least two preset angles is more than or equal to the option number, and

establishing a mapping relationship between each angle of the preset angles whose number is equal to the option number and each option according to the option information of the at least two options.

In some feasible implementation ways, in detail, the processor 300 determining orientation information of a terminal when the terminal scans the target two dimension code, includes:

determining a direction of a scanning line of the terminal when the terminal scans the target two dimension code;

determining a direction of a horizontal line corresponding to a current position of the target two dimension code according to a location detecting graph and a positioning graph of the target two dimension code; and

determining a slant angle between the terminal and the target two dimension code according to the direction of the horizontal line and the direction of the scanning line.

In some feasible implementation ways, the terminal may also include an orientation sensor (not shown in FIG. 7), such as a gravity sensor, a gyroscope or a geomagnetic sensor, etc. The processor 300 determining orientation information of a terminal when the terminal scans the target two dimension code includes determining the orientation information of the terminal when the terminal scans the target two dimension code by use of a gravity sensor, a gyroscope or a geomagnetic sensor.

In some feasible implementation ways, the option information includes option identifiers and web sites. In detail, the output device 200 displaying the at least two options, and highlighting the target option according to the option information of the at least two options, includes:

displaying option identifiers of the at least two options, and highlighting the option identifier of the target option according to the option information of the at least two options;

the output device 200 outputting a content corresponding to option information of the target option, includes:

displaying a webpage corresponding to a web site in the option information according to the option information of the target option.

In some feasible implementation ways, the option information includes option identifiers and contact information. In detail, the output device 200 displaying the at least two options, and highlighting the target option according to the option information of the at least two options, includes:

displaying option identifiers of the at least two options, and highlight the option identifier of the target option according to the option information of the at least two options;

the output device 200 outputting a content corresponding to option information of the target option, includes:

displaying the contact information corresponding to the option information according to the option information of the target option.

In some feasible implementation ways, the option information includes option identifiers and product information. In detail, the output device 200 displaying the at least two options, and highlighting the target option according to the option information of the at least two options, includes:

displaying option identifiers of the at least two options, and highlight the option identifier of the target option according to the option information of the at least two options; and

the output device 200 outputting a content corresponding to option information of the target option, includes:

displaying the product information corresponding to the option information according to the option information of the target option.

In some feasible implementation ways, the output device 200 displaying option identifiers of the at least two options according to the option information of the at least two options, includes:

the processor 300 determining the option information of each option according to a preset separator between the option information of the at least two options stored in the target two dimension code;

the processor 300 establishing an association relationship between an option identifier and a web site of each option; and

the output device 200 displaying the option identifiers of the at least two options.

In some feasible implementation ways, before determining orientation information of a terminal when the terminal scans the target two dimension code, the processor 300 further executes for:

determining whether the option information of the at least two options is complete or not;

determining the orientation information of a terminal when the terminal scans the target two dimension code when the option information of the at least two options is complete;

outputting a reminder of scanning failure when the option information of the at least two options is not complete.

In specific implementations, the input device 100, output device 200 and processor 300 can be used to execute the implementation ways described in the above embodiments, and related technical details can be seen by reference to the above embodiments, so it is unnecessary to go into details here.

In the terminal described in this embodiment, when scanning a target two dimension code, the terminal determines orientation information of the terminal. Wherein, the target two dimension code stores option information of at least two options. In addition, the terminal determines a target option corresponding to the orientation information according to a mapping relationship between scanning orientations and the at least two options, and outputs a content corresponding to the option information of the target option. By employing, this embodiment, when a user scans a two dimension code by use of the terminal, the terminal can output corresponding target contents according to scanning orientations of the terminal, which can improve operability of the two dimension code during operating.

All units in the all embodiments of the present disclosure can be realized by an integrated circuit, such as a CPU, or an application specific integrated circuit (ASIC).

The steps of the methods described in the embodiments of the present disclosure can be adjusted in sequence, combined and deleted according to actual requirements.

The units described in the embodiments of the present disclosure can be combined, divided and deleted according to actual requirements.

A person having ordinary skills in the art can realize that part or whole of the processes in the methods according to the above embodiments may be implemented by a computer program instructing relevant hardware. The program may be stored in a computer readable storage medium, and when executed, the program may execute processes in the above-mentioned embodiments of methods. Wherein, the storage medium may be a magnetic disk, an optical disk, a read-only memory (ROM) or a random access memory (RAM), et al. While the present disclosure has been described with reference to particular embodiments, it will be understood that the embodiments are illustrative and that the disclosure scope is not so limited. Alternative embodiments of the present disclosure will become apparent to those having ordinary skill in the art to which the present disclosure pertains. Such alternate embodiments are considered to be encompassed within the spirit and scope of the present disclosure.

1. A two dimension code operating method, comprising:
scanning a target two dimension code; wherein, the target two dimension code stores option information of at least two options;
determining orientation information of a terminal when the terminal scans the target two dimension code;
determining a target option corresponding to the orientation information according to a mapping relationship between scanning orientations and the at least two options; and
outputting a content corresponding to the option information of the target option.

2. The two dimension code operating method according to claim 1, wherein, before the outputting a content corresponding to the option information of the target option, the two dimension code operating method further comprises:
displaying the at least two options, and highlighting the target option according to the option information of the at least two options; and
executing the outputting a content corresponding to the option information of the target option when receiving a confirmation instruction corresponding to the target option or when not receiving a confirmation instruction corresponding to any option in a preset duration.

3. The two dimension code operating method according to claim 1, wherein, before the outputting a content corresponding to the option information of the target option, the two dimension code operating method further comprises:
displaying the target option according to the option information of the target option; and
executing the outputting a content corresponding to the option information of the target option when receiving a confirmation instruction corresponding to the target option or when not receiving a confirmation instruction corresponding to the target option in a preset duration.

4. The two dimension code operating method according to claim 1, wherein, the orientation information comprises a slant angle between the terminal and the target two dimension code;
after the scanning a target two dimension code, the two dimension code operating method further comprising:
determining the option number of the at least two options according to the option information of the at least two options;
dividing 0 to 360 degrees into several pieces whose number is equal to the option number, and determining the angle corresponding to the boundary of each piece; and
establishing a mapping relationship between each angle and each option according to the option information of the at least two options.

5. The two dimension code operating method according to claim 1, wherein, the orientation information comprises a slant angle between the terminal and the target two dimension code;
after the scanning a target two dimension code, the two dimension code operating method further comprising:
determining the option number of the at least two options according to the option information of the at least two options;
acquiring at least two preset angles;
selecting the preset angles whose number is equal to the option number from the at least two preset angles when the angle number of the at least two preset angles is more than or equal to the option number; and
establishing a mapping relationship between each angle of the preset angles whose number is equal to the option number and each option according to the option information of the at least two options.

6. The two dimension code operating method according to claim 4, wherein, the determining orientation information of a terminal when the terminal scans the target two dimension code, comprises:
determining a direction of a scanning line of the terminal when the terminal scans the target two dimension code;
determining a direction of a horizontal line corresponding to a current position of the target two dimension code according to a location detecting graph and a positioning graph of the target two dimension code; and
determining the slant angle between the terminal and the target two dimension code according to the direction of the horizontal line and the direction of the scanning line.

7. (canceled)

8. The two dimension code operating method according to claim 2, wherein, the option information comprises option identifiers and web sites;
the displaying the at least two options, and highlighting the target option according to the option information of the at least two options, comprising:
displaying the option identifiers of the at least two options, and highlighting the option identifier of the target option according to the option information of the at least two options; and
the outputting a content corresponding to the option information of the target option, comprising:
displaying, according to the option information of the target option, a webpage corresponding to the web site in the option information.

9. (canceled)

10. The two dimension code operating method according to claim 2, wherein, the option information comprises option identifiers and contact information;
the displaying the at least two options, and highlighting the target option according to the option information of the at least two options, comprising:
displaying the option identifiers of the at least two options, and highlighting the option identifier of the target option according to the option information of the at least two options; and
the outputting a content corresponding to the option information of the target option, comprising:
displaying the contact information corresponding to the option information according to the option information of the target option.

11. The two dimension code operating method according to claim 2, wherein, the option information comprises option identifiers and product information;
the displaying the at least two options, and highlighting the target option according to the option information of the at least two options, comprising:
displaying the option identifiers of the at least two options, and highlighting the option identifier of the target option according to the option information of the at least two options; and
the outputting a content corresponding to the option information of the target option, comprising:
displaying the product information corresponding to the option information according to the option information of the target option.

12. (canceled)

13. A terminal, comprising:
a scanning unit, configured to scan a target two dimension code; wherein, the target two dimension code stores option information of at least two options;
a first determining unit, configured to determine orientation information of the terminal when the terminal scans the target two dimension code;
a second determining unit, configured to determine a target option corresponding to the orientation information according to a mapping relationship between scanning orientations and the at least two options; and
an outputting unit, configured to output a content corresponding to the option information of the target option.

14. The terminal according to claim 13, wherein, the terminal further comprises a first displaying unit, and the first displaying unit is configured to:
display the at least two options, and highlight the target option according to the option information of the at least two options; and
the outputting unit is configured to output the content corresponding to the option information of the target option when receiving a confirmation instruction corresponding to the target option or when not receiving a confirmation instruction corresponding to any option in a preset duration.

15. The terminal according to claim 13, wherein, the terminal further comprises a second displaying unit, and the first displaying unit is configured to:
display the target option according to the option information of the at least two options; and
the outputting unit is configured to output the content corresponding to the option information of the target option when receiving a confirmation instruction corresponding to the target option or when not receiving a confirmation instruction corresponding to the target option in a preset duration.

16. The terminal according to claim 13, wherein, the orientation information comprises a slant angle between the terminal and the target two dimension code; and the terminal further comprises a third determining unit and a first establishing unit, and the third determining unit is configured to:
determine the option number of the at least two options according to the option information of the at least two options;
the third determining unit is further configured to divide 0 to 360 degrees into several pieces whose number is equal to the option number, and determine the angle corresponding to the boundary of each piece; and
the first establishing unit is configured to establish a mapping relationship between each angle and each option according to the option information of the at least two options.

17. The terminal according to claim 13, wherein, the orientation information comprises a slant angle between the terminal and the target two dimension code; and the terminal further comprises a fourth determining unit, an acquiring unit, a selecting unit and a second establishing unit;
the fourth determining unit is configured to determine the option number of the at least two options according to the option information of the at least two options;
the acquiring unit is configured to acquire at least two preset angles;
the selecting unit is configured to select the preset angles whose number is equal to the option number from the at least two preset angles when the angle number of the at least two preset angles is more than or equal to the option number; and
the second establishing unit is configured to establish a mapping relationship between each angle of the preset angles whose number is equal to the option number and each option according to the option information of the at least two options.

18. The terminal according to claim 16, wherein, the first determining unit comprises:
a scanning line direction determining unit, configured to determine a direction of a scanning line of the terminal when the terminal scans the target two dimension code;
a horizontal line direction determining unit, configured to determine a direction of a horizontal line corresponding to a current position of the target two dimension code according to a location detecting graph and a positioning graph of the target two dimension code; and
a slant angle determining unit, configured to determine the slant angle between the terminal and the target two dimension code according to the direction of the horizontal line and the direction of the scanning line.

19. (canceled)

20. The terminal according to claim 14, wherein, the option information comprises option identifiers and web sites;
the first displaying unit is configured to:
display the option identifiers of the at least two options, and highlight the option identifier of the target option according to the option information of the at least two options; and
the outputting unit is configured to:
display, according to the option information of the target option, a webpage corresponding to the web site in the option information.

21. (canceled)

22. The terminal according to claim 14, wherein, the option information comprises option identifiers and contact information;
the first displaying unit is configured to:
display the option identifiers of the at least two options, and highlight the option identifier of the target option according to the option information of the at least two options; and
the outputting unit is configured to:
display the contact information corresponding to the option information according to the option information of the target option.

23. The terminal according to claim 14, wherein, the option information comprises option identifiers and product information;
the first displaying unit is configured to:
display the option identifiers of the at least two options, and highlight the option identifier of the target option according to the option information of the at least two options; and
the outputting unit is configured to:
display the product information corresponding to the option information according to the option information of the target option.

24. (canceled)

25. A terminal, comprising at least one input device, at least one output device, at least one processor and a memory, wherein, the memory is configured to store a group of program codes, and the processor is configured to call the program codes stored in the memory to execute for:
scanning a target two dimension code; wherein, the target two dimension code stores option information of at least two options;
determining orientation information of a terminal when the terminal scans the target two dimension code;
determining a target option corresponding to the orientation information according to a mapping relationship between scanning orientations and the at least two options; and
outputting a content corresponding to the option information of the target option.

26. The terminal according to claim 25, wherein, the orientation information comprises a slant angle between the terminal and the target two dimension code;
and the processor is configured to call the program codes stored in the memory to execute for:
determining the option number of the at least two options according to the option information of the at least two options;
dividing 0 to 360 degrees into several pieces whose number is equal to the option number, and determine the angle corresponding to the boundary of each piece; and
establishing a mapping relationship between each angle and each option according to the option information of the at least two options.
